(19) United States
(12) Patent Application Publication
(10) Pub. No.: US 2024/0352773 A1
(43) Pub. Date: Oct. 24, 2024

(54) LOCKING PLATFORM FOR RECEIVING A MOUNT

(71) Applicant: Rodin O'HAGAN, London (GB)

(72) Inventor: Rodin O'HAGAN, London (GB)

(21) Appl. No.: 18/643,997

(22) Filed: Apr. 23, 2024

(30) Foreign Application Priority Data
Apr. 24, 2023 (GB) 2305975.1

(51) Int. Cl. E05B 73/00; B62H 5/00

(52) U.S. Cl. CPC E05B 73/0005; B62H 5/001

(57) ABSTRACT

The present invention relates to a locking platform for receiving a mount comprising: a plate containing a lock mechanism that engages and disengages at least one locking member.

A first face of the plate receives the mount, and the first face of the plate has an opening through which the at least one locking member projects to engage with the mount release mechanism; and retracts to disengage from the mount release mechanism.

A second opposed face of the plate is adapted to receive a base whereby in use part of the plate is sandwiched between the mount and the base.

At least one aperture is provided through the plate, between the first and second faces of the plate, to receive an attachment means for joining the plate to the mount and the base.

### FIELD OF THE INVENTION

The present invention relates to a locking platform for receiving a mount for a device, in particular a locking platform that engages with the mount to prevent removal of the device held by the mount.

### BACKGROUND

It is often necessary to connect an electrical device, such as navigation aid to a vehicle. When the vehicle is not enclosed, such as a motorcycle, bicycle, quad bike, or other open vehicle, it is often preferred to remove the device from the vehicle when not attended to prevent likelihood of theft or damage.

Some lockable mounts are provided to lock a device to the mount so that it is secured to the mount, but such mounts do not specifically prevent removal of the mount from the vehicle which is simply connected by an exposed attachment means. Therefore theft of the device is still a risk if the attachment means of the mount are overcome. The present invention overcomes this problem.

### PRIOR ART

Touratech Garmin Zumo XT Locking Mount (https://www.touratech-uk.co.uk/handlebar-mount-for-garmin-zumo-xt-lockable-black.html) discloses a lockable mount that can receive an electronic device.

Zumolock https://www.zumolock.com/index.php/en/information discloses an anti-theft solution placed between a mount and the RAM ball plate.

### SUMMARY OF THE INVENTION

According to a first aspect of the present invention there is provided a locking platform for receiving a mount comprising: a plate containing a lock mechanism that engages and disengages at least one locking member; wherein a first face of the plate receives the mount and the first face of the plate has an opening through which the at least one locking member projects to engage with a mount release mechanism; and retracts to disengage from the mount release mechanism; and a second opposed face of the plate is adapted to receive a base whereby in use at least part of the plate is sandwiched between the mount and the base; at least one aperture is provided through the plate, between the first and second faces of the plate, to receive an attachment means for joining the plate to the mount and the base; and a key region is provided on the same face of the platform for receiving a device to the mount so that a user facing portion of the device and the key region are accessed from the same direction by a user.

In this way a mount for an electronic device such as a Global Positioning System (GPS) device can be securely fixed to a vehicle such as a motorcycle on a mount and the lock mechanism prevents unauthorised removal or accidental release of the electronic device from the mount by stopping use of the mount release mechanism.

Advantageously the locking platform is designed to be fitted to standard fixings or fittings on a vehicle so that the platform can be used with existing equipment. Additionally, access to the lock itself is from the same direction as the device inserts into (is received to) the mount, therefore ensuring convenient use of the lock, unlike other locks that demand key entry from the sides and top of the device, which are often blocked or restricted but surrounding accessories or objects surrounding the mounting point.

The locking mechanism is preferably fully enclosed within the locking platform so that the locking mechanism is concealed and protected and only the at least one locking member is projected for engagement with a mount release mechanism. This configuration provides enhanced security as the locking mechanism cannot be tampered with and longevity as parts of the locking mechanism are protected.

By using the locking platform a user may leave the electronic device in place and electrically connected to the vehicle when unattended without risk of the device being stolen.

The plate is received in use between a base that is attached to, or forms part of the vehicle, and a mount. Typically the plate is planar so as to easily fit between the two parts (base and mount) that may usually directly connect to each other.

The plate has an internal cavity which houses the lock mechanism. In this way the lock mechanism is not accessible and cannot be tampered with during use to enable release of the device from the mount. The lock mechanism is intended to prevent functioning of the mount release mechanism and therefore it is appreciated that different lock mechanisms may be provided for different mounts.

In a preferred embodiment, the first face of the plate that receives the mount has an opening through which the at least one locking member projects to engage with the mount release mechanism and retracts to disengage from the mount release mechanism. The locking member may be provided in a compartment of the plate. The locking member is intended to engage with part of the mount release mechanism that prevents disengagement of a device from the mount, for example preventing use of a quick release button or twist lock function that enables a device to be fitted to a mount. In this way it is not possible to remove the device from the mount when the locking member is projected and inserted to an aperture on the mount that is in communication with the mount release mechanism.

The locking member(s) is connected to the lock mechanism so that the locking member moves when the lock mechanism is engaged or disengaged. This ensures that when the lock mechanism is in a locked configuration that the locking member(s) is projected from the opening and engaged with the mount release mechanism and when the lock mechanism is in the unlocked configuration the locking member(s) is retracted within the opening and is not engaged with the mount release mechanism.

The second opposed face of the plate is adapted to be positioned adjacent to a base so that the plate and mount become attached to the base. The base may be a fitting on the vehicle which is intended to receive a mount, or the base may be part of the vehicle that is suitable for receiving a mount.

The base, plate and mount are joined together by attachment means. In preferred embodiments the attachment means are a threaded bolt that passes through apertures in the mount and plate and engages with holes in the base to lock all parts together.

Ideally there may be a plurality of apertures through the plate, so that the plate is fixed in multiple locations and/or so the plate can be adapted for use with different bases that may have different arrangements of connection means.

Typically the bolt heads are located so as to be on part of the mount that is covered by the device when it is fitted to the mount, to prevent access during use so that it is not possible to remove the attachment means when a device is locked in the mount.

Preferably the lock mechanism is disengaged and/or engaged by a key so that unauthorised disengagement is prevented without the key. The key may be a mechanical key or an electrical or digital key.

A mechanical key provides a simple means to unlock and lock the position of the locking member(s) by inserting a key into a barrel and turning the key.

An electrical key, such as a key fob may enable a user to present the key fob to generate an electric current that causes locking and unlocking of the lock mechanism. For example the key fob may generate and electromagnetic pulse to lock and/or unlock the lock mechanism.

In a preferred embodiment with an electrical or digital key the lock is mechanical and the actuation of the lock is electronically activated. In this way it is appreciated that the lock components may be substantially the same for a mechanical or electronic key and different embodiments of the platform may be provided so that a user may select their preferred key. This enables different embodiments of the locking platform to be manufactured in a near similar way with only the key and key activation mechanism being changed.

Typically a platform including an electronic key has at least one battery and at least one receiver provided to receive a signal from the electric key to an actuation means to actuate the lock. For example the electronic key may be operable by means of a Radio frequency Identification (RFID) tag or near-filed communication (NFC) tag. Preferably the actuation means includes a solenoid to lock and unlock the lock mechanism.

In some embodiments the platform may additionally or alternatively include at least one sensor to transmit an activation signal to the lock.

It is appreciated that a platform with an electronic key may include a microprocessor to detect and analyse lock signals such as a signal to lock the device to the mount and a signal to release the device from the mount. The microprocessor may be provided on a printed circuit board in communication with at least one battery and a receiver and/or sensor. The electrical components are typically wired allowing the components to be fitted close to, or remote, from the lock within the platform.

In a preferred embodiment the actuation means for an electronic key may be arranged at or near to a lock pawl that forms part of the lock mechanism to minimise linkage that may be required for a platform with a mechanical key which may require additional space to locate the physical key receiving part whilst also ensuring it is easy to access the keyhole when a device is fitted to the mount.

In a preferred embodiment of the platform with an electronic key the platform includes a lock reset system to enable the lock to be reset under set conditions. For example the reset system may only permit reset when an authorised user is identified to prevent unauthorised removal of the electronic device from the mount.

In some embodiments the locking platform may include an access panel such as a key pad for receiving a code, or biometric identification means such as a fingerprint recognition module that permits selective unlocking when the correct authorisation is detected, for example the correct code, or an authorised fingerprint.

In a preferred embodiment the plate has an arm that spaces apart the region from where the mount is received from the region where the key is received. In this way access to the key region is not restricted by the device, so a user can easily lock and unlock the device from the mount.

The region where the key is received/presented matches the orientation of the user facing portion of the device that is fitted to the mount and locking platform. In this way the key entry region is provided on the same face of the platform that receives the device so that a user facing portion of the device and the key region are accessed from the same direction by a user. Advantageously this increases ease of use since the key region is easily accessible and easily identified even in low light or darkness.

In preferred embodiments the locking platform includes a push mechanism such as a button or lever operated push mechanism that is in communication with the lock mechanism for engaging the at least one locking member.

Preferably the push mechanism is operative to contact the lock mechanism to engage the at least one locking member. In this way the lock mechanism can be engaged without requirement for a key. Advantageously this allows the device to be quickly and easily fitted without the key.

Preferably the travel re required by the button to engage to lock is exaggerated, to give positive feedback to cold and/or gloved hands. The exaggerated movement may be provided as a ratio of movement of the push mechanism button relative to movement of the/each locking member. In a preferred embodiment the ratio is 1:0.3. For example, for button travel of 10 mm an output of 3 mm movement is achieved by the locking member.

In some embodiments the plate includes at least one cable clip for securing and guiding the cable of the electronic device in a fixed position.

Preferred embodiments of the invention will now be described, by way of example and with reference to the Figures in which:

### BRIEF DESCRIPTION OF FIGURES

FIG. 1 shows an exploded view of a locking platform and the mount;

FIG. 2A shows a top view of the locking platform and the mount;

FIG. 2B shows a front view of the locking platform and the mount;

FIG. 2C shows a side view of the locking platform and the mount;

FIG. 2D shows a rear view of the locking platform and the mount with part of the plate removed to reveal the lock mechanism;

FIG. 2E shows a bottom view of the locking platform and the mount;

FIG. 2F shows a front perspective view of the locking platform and the mount;

FIG. 2G shows a rear perspective view of the locking platform and the mount with part of the plate removed to reveal the lock mechanism;

FIGS. 3A to 3D show perspective views of the locking platform and the mount;

FIG. 4A shows a rear view of the locking platform in the unlocked configuration;

FIG. 4B shows a rear view of the locking platform in the locked configuration;

FIG. 5A show a locking platform with a mount showing examples of where an arm with the lock may be provided in different embodiments;

FIG. 5B shows two variations of the plate wherein the thickness is varied to accommodate different space, bases and/or mounts;

FIG. 5C shows front views of two variations of the plate adapted for different sized mounts;

FIG. 6A shows a base on a motorcycle handlebar, a plate and a mount sandwiched either side of a locking platform; and

FIG. 6B shows the locking platform fitted to a motorcycle.

### DETAILED DESCRIPTION OF FIGURES

The locking platform 100 for receiving a mount 200 comprises a plate 50 containing a lock mechanism 60 that engages and disengages at least one locking member 20.

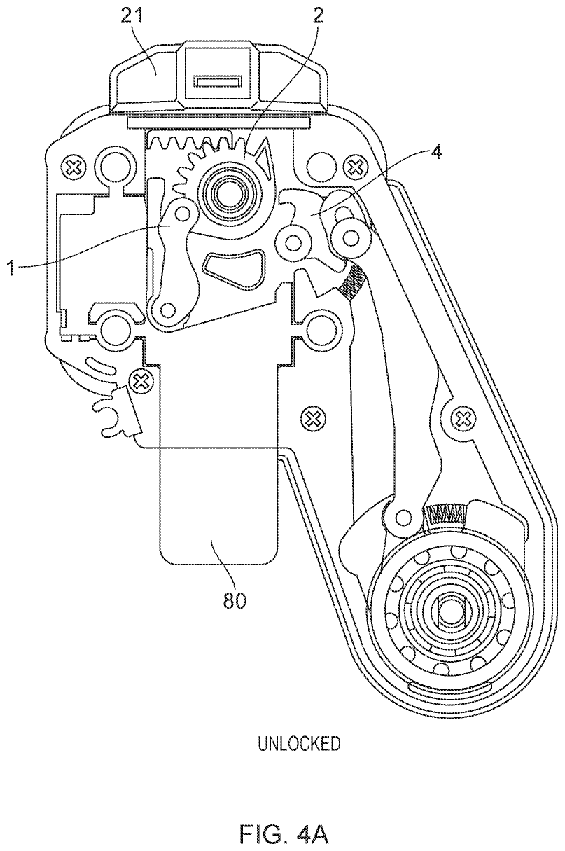

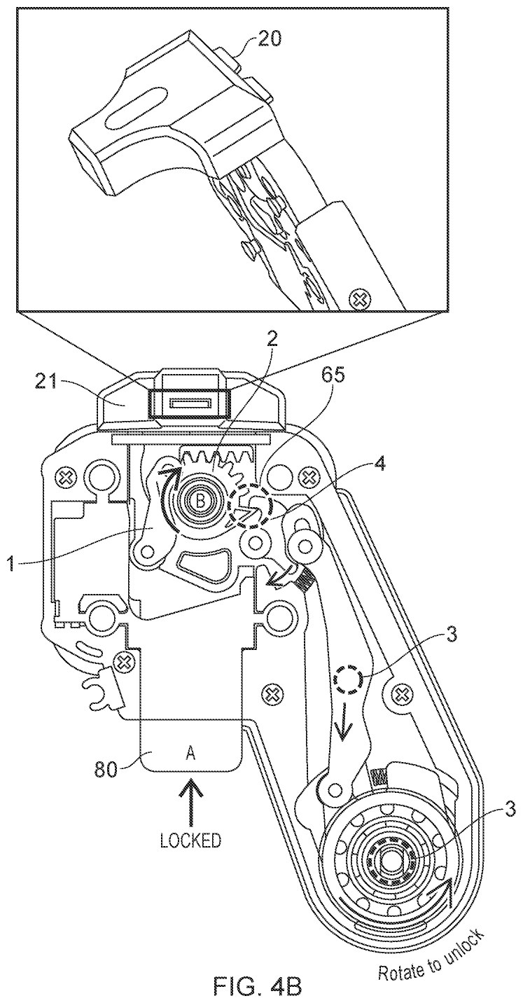

A first face ‘A’ of the plate 50 receives the mount 200 and the first face of the plate has an opening (see FIG. 4B) through which the at least one locking member 20 projects to engage with a mount release mechanism; and retracts to disengage from the mount release mechanism.

A second opposed face ‘B’ of the plate 50 is adapted to receive a base 300 whereby in use at least part of the plate 50 is sandwiched between the mount 200 and the base 300

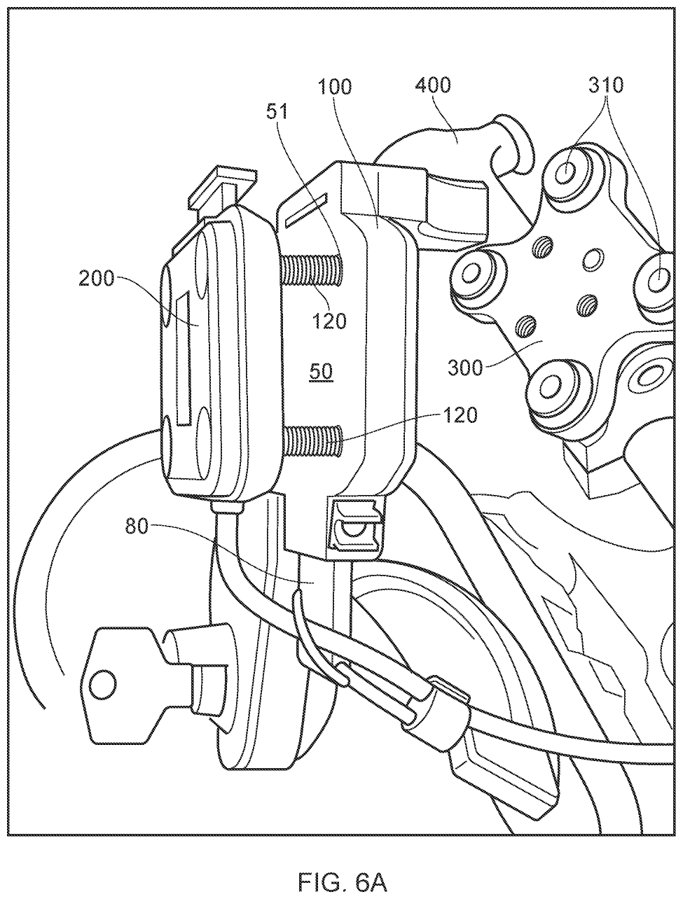

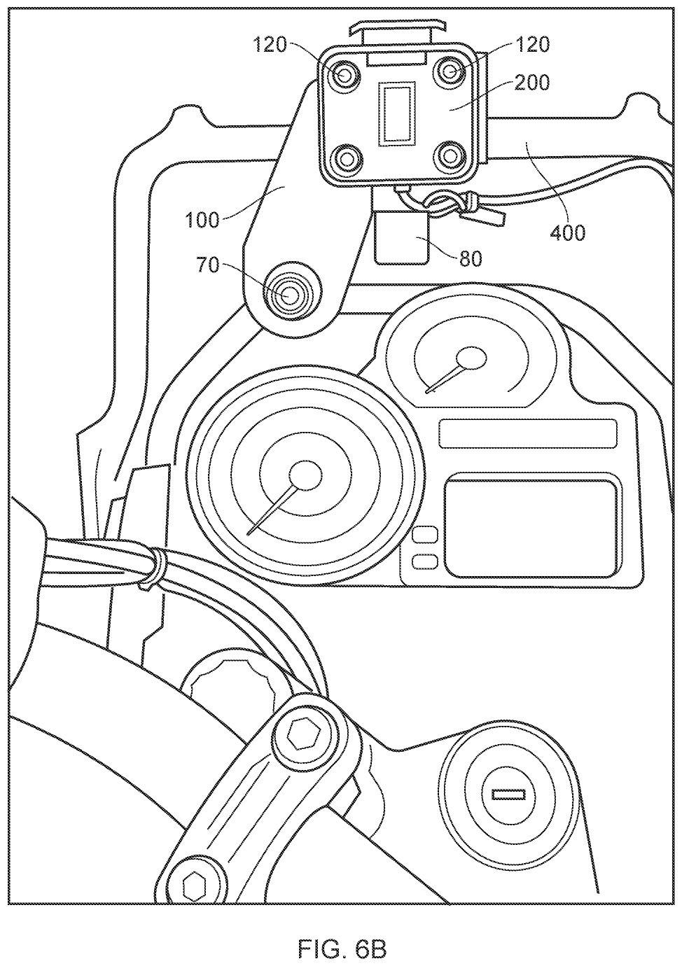

Four apertures 51 are provided through the plate 50, between the first ‘A’ and second ‘B’ faces of the plate, to receive an attachment means 120 for joining the plate 50 to the mount 200 and the base 300 (see FIG. 6A).

A key region 70 is provided on the same face ‘A’ of the platform 100 that receives the device (not shown) so that a user facing portion of the device and the key region 70 are accessed from the same direction by a user.

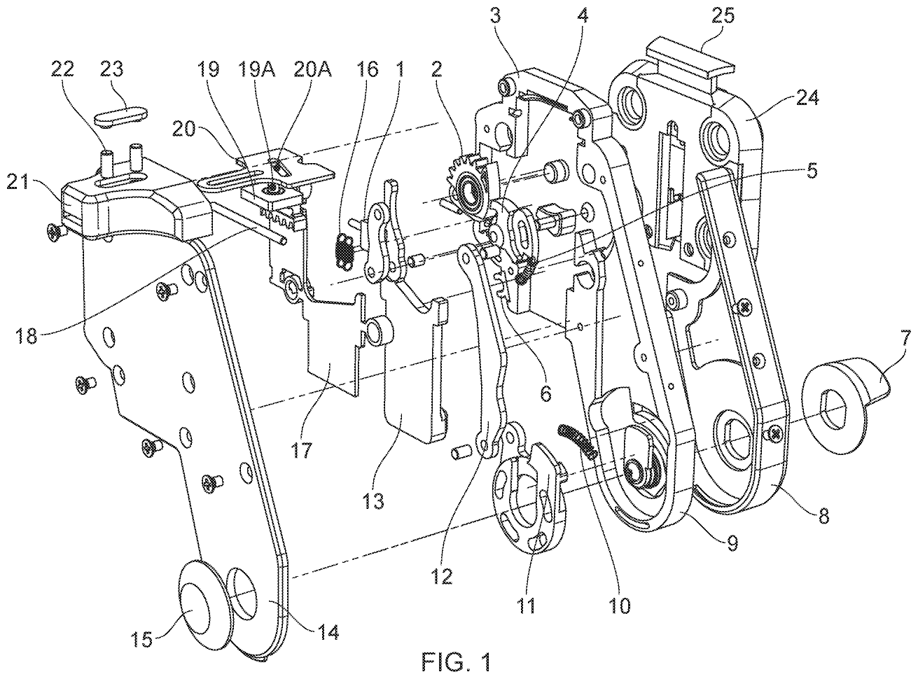

FIG. 1 shows a rear exploded view of a locking platform 100 and the mount 24.

The lock mechanism 60 is formed from a number of components enclosed within the plate 50.

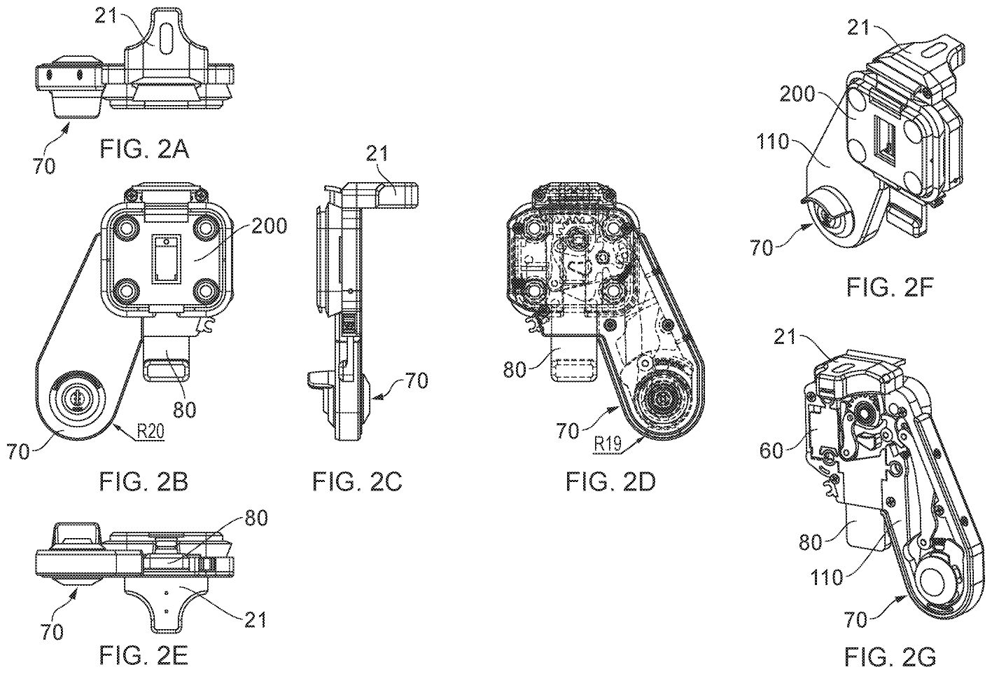

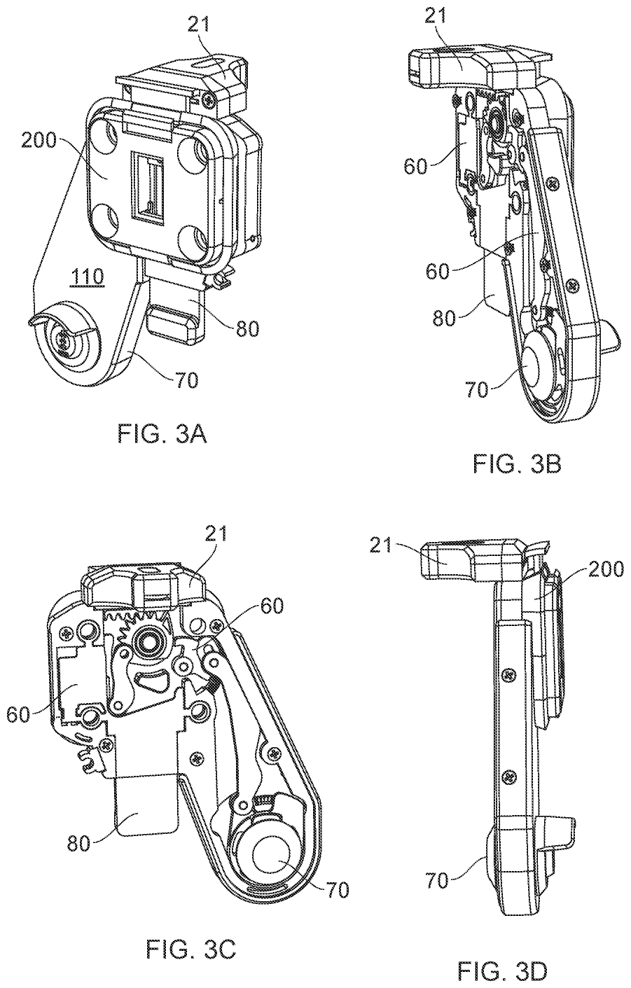

The lock mechanism 60 in the pictured embodiment includes:
1 Drive lever (main gear)
2 Lever actuated gear
3 Main support chassis
4 Lock pawl
5 Lock pawl return spring
6 A cable guide
8 A cover plate
12 A pawl linkage bar
13 (FIG. 1), 80 (FIGS. 2 to 6) Push button
14 Main cover plate
16 Tension springs (×2)
17 Internal restraining plate
18 Rack guide rail
19 Sliding pin mount
20 Lock blade (notched)
21 Lock blade housing
22 Lock blade guide pins (×3)
23 Pin cover plate
24 (FIG. 1) 200 (FIGS. 2 to 6) Mount
25 Mount release plunger

A physical key (not shown) is used to operate the lock mechanism 60.

The key (not shown) is inserted into a lock 70 that includes:
7 An exterior lock shroud
9 A lock unit
10 A lock drive ring return spring
11 A pawl linkage ring
15 A back cover cone for the lock

The pawl linkage drive ring 11 is connected to a first end of the pawl linkage bar 12 so that when the key is turned in the lock the pawl linkage drive ring 11 rotates which moves position of the pawl linkage bar 12. A second end of the pawl linkage bar 12 is connected to a lock pawl 4 which is moveable between unlocked and locked orientations (see FIGS. 4A and 4B), as the lock pawl 4 engages and disengages with the gear 2 that is responsible for position of the locking members 20. The lock pawl 4 is connected to a lock pawl spring 5, so that the lock pawl is sprung.

A compartment 21 contains the locking member 20. The compartment 21 extends from a rear face of the plate 50. The compartment 21 has a pin cover plate 23.

The components of the lock mechanism 60 and the compartment 21 are arranged on or connect to the main support chassis 3. The main support chassis 3 receives the cover plat 8 on one face and the main cover plate 14 on the opposed face that together provide a housing that enclosed the components of the lock mechanism 60 and lock 70.

A cable guide 6 is provided for supporting a mount power cable when present and stores the cable clear of the button mechanism as well as guiding it through the device along a predefined route.

The internal restraining plate 17 encloses the tension springs 16 thereby containing any spring deformation during operation.

The mount 24 is attached to a front face ‘A’ of the locking platform 100 so that the device (not shown) held in the mount 24 is presented to a user of the vehicle.

The mount 24 has a plunger release 25 that becomes locked when engaged with the locking platform 100 so that the device cannot be released.

FIG. 2A to FIG. 2G shows views of an assembled locking platform 100 that is attached to a mount 200. The lock 70 is arranged at a distal end of an arm 110 of the plate 50. This allows the key to easily be inserted to the lock 70 without being obstructed by the mount 200 or device (not shown) held on the mount.

The locking platform has a button 80 that push activates the lock mechanism so that the electronic device (not shown), can be locked to the mount and thereby to the locking platform, without requirement for the key. In this way the key is provided to unlock the lock mechanism 60, but is not essential for locking the lock mechanism 60 as this can be achieved by means of the button 80.

FIG. 4A shows a rear view of the locking platform in the unlocked configuration and FIG. 4B shows a rear view of the locking platform in the locked configuration.

The parts of the lock mechanism 60 (see above) are connected together as a linkage so that when the button 80 is pressed the gear 2 rotates to force the locking member 20 out from the compartment 21 to an opening on the mount 200. Gear 2 is connected to a sliding pin mount with a rack 19 which holds a pin 19A located into an angled slot 20A in member 20, changing direction of the drive train motion, forcing inward and outward movement of member 20. This provides a compact and reliable means to change direction of applied force so that the locking platform 100 is compact. The locking member 20 is prevented from retracting into the compartment 21 because the lock pawl 4 is locked against the gear 2 at a locking point 65 to prevent rotation and thereby preventing release of the locking member 20. The connection mechanism of the rack 19 to member 20 prevents forced reversal of the mechanism when driven by member 20. The mechanism can only be driven by the rack 19 and gear 2.

When a key is inserted into the lock 70 and turned the lock mechanism 60 is unlocked so that the pawl linkage bar 12 that is connected to the lock 70 (connected to the lock drive link ring 11) is pulled downwards so that the lock pawl 4 rotates so as to be released from the gear 2 and therefore the locking member 20 is released from the mount and retracts into the compartment 21.

This happens because when in the ‘locked’ state, the linkage train is loaded under tension by the two tension springs 16.

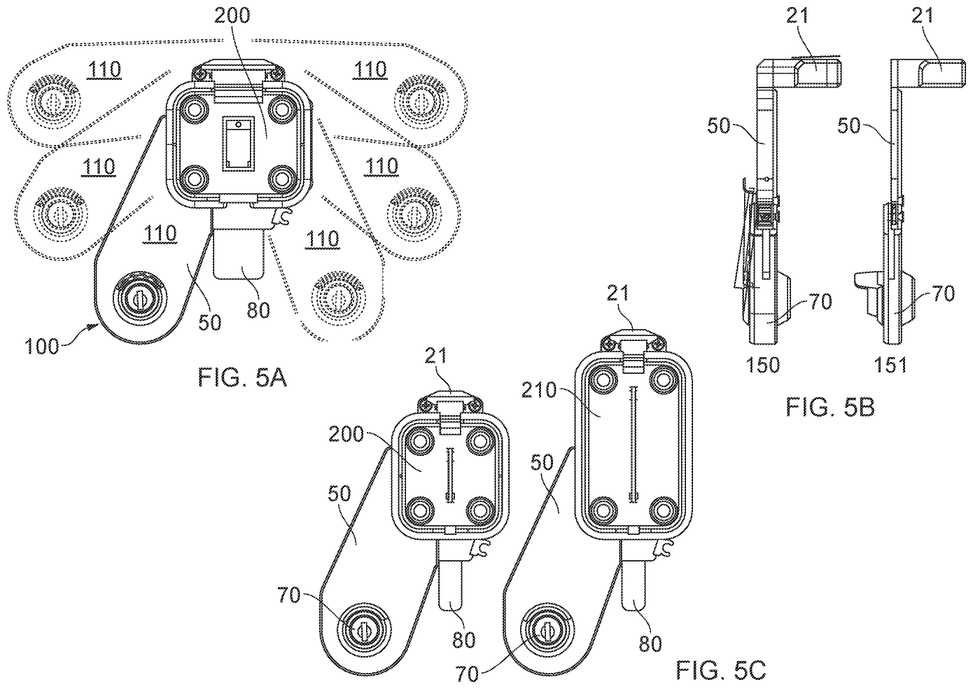

FIG. 5A shows the locking platform 100 with alternative positions of the arm 110 indicated so show that the locking platform may be made in various different embodiments to be suitable for different users. For example the platform and/or the position of the arm may be shaped/located to be left or right handed, or to accommodate different fitting locations on a vehicle, or for best visibility and usability.

FIG. 5B shows two variations of the platform 150, 151 without a mount wherein the thickness of the plate is varied to accommodate different bases and/or mounts. Platform 150 has a thicker plate than locking platform 151. The features of each embodiment are the same, but the thickness of the plate 50 is different.

FIG. 5C shows front views of two variations of the plate adapted for different sized mounts. In these embodiments the shape of the plate 50 is changed to accommodate different mounts 200, 210. It is appreciated that the lock mechanism within the plate 50 may be reconfigured and/or scaled to correspond to dimensions of the plate 50 and proximity to the lock 70.

FIGS. 6A and 6B show a base 300 on a motorcycle 400, a lockable platform 100 arranged between the base 300 and the mount 200. The base 300, platform 100 and mount 200 are locked together by four bolts 120 that are inserted through apertures 51 on the plate 50, into threaded apertures 310 on the base.

The invention has been described by way of examples only and it will be appreciated that variation may be made to the above-mentioned embodiments without departing from the scope of invention as defined by the claims.

1. A locking platform for receiving a mount comprising: a plate containing a lock mechanism that engages and disengages at least one locking member; wherein a first face of the plate receives the mount and the first face of the plate has an opening through which the at least one locking member projects to engage with a mount release mechanism; and retracts to disengage from the mount release mechanism; and a second opposed face of the plate is adapted to receive a base whereby in use at least part of the plate is sandwiched between the mount and the base; at least one aperture is provided through the plate, between the first and second faces of the plate, to receive an attachment means for joining the plate to the mount and the base; and a key region is provided on the same face of the platform that receives the device so that a user facing portion of the device and the key region are accessed from the same direction by a user.

2. A locking platform according to claim 1 wherein the lock mechanism is disengaged and/or engaged by a mechanical key at the key region.

3. A locking platform according to claim 1 wherein the lock mechanism is disengaged and/or engaged by an electrical or digital key at the key region.

4. A locking platform according to claim 1 including a push mechanism (button) which is operative to contact the lock mechanism to engage the at least one locking member.

5. A locking platform according to claim 4 wherein the push mechanism has a travel ratio of 1:0.3 in respect of the push mechanism travel relative to the locking member travel.

6. A locking platform according to claim 1 wherein the attachment means comprises at least one threaded bolt.

7. A locking platform according to claim 2 wherein the plate has an arm that spaces apart the first face of the plate, on which the mount is received, from the region which receives the key.

8. A locking platform according to claim 1 including at least one cable clip.
